(19) United States
(12) Patent Application Publication
(10) Pub. No.: US 2008/0218492 A1
(43) Pub. Date: Sep. 11, 2008

(54) Touch panel

(75) Inventor: Michiko Endo, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Shinagawa (JP)

(21) Appl. No.: 12/073,689

(22) Filed: Mar. 7, 2008

(30) Foreign Application Priority Data
Mar. 9, 2007 (JP) 2007-60261

(51) Int. Cl. G06F 3/041

(52) U.S. Cl. 345/173

(57) ABSTRACT

A touch panel which is not deteriorated in the linearity of electric potential gradient despite having a protruding portion. In the touch panel, the local protruding region of at least one of a pair of electrode plates is electrically insulated from the transparent conductive film. The at least one electrode plate is formed so that the local protruding region electrically insulated from the transparent conductive film includes a protruding board portion locally protruding outward from a region of each insulating board located between a pair of electrodes. The local protruding region of the at least one electrode plate includes a second conductive film provided on one surface of the protruding board portion; the second conductive film is insulated from the transparent conductive film.

### BACKGROUND OF THE INVENTION

1. Field of the Invention

The present invention relates to a structure of a touch panel.

2. Description of the Related Art

To use various kinds of electronic devices efficiently, a touch panel to input a signal through a display screen such as a liquid crystal display (LCD) has been widely used instead of using a remote controller or separate input device. Such touch panel includes: a pair of electrode plates each having an insulating board, a transparent conductive film provided on a surface of the insulating board, a pair of electrodes connected to the transparent conductive film, and a local protruding region in an outer edge portion thereof, and assembled into a relative relation such that the transparent conductive films are opposed to and spaced apart from each other, but can be brought into electrical contact; and, a flexible wiring board held between the local protruding regions, and having conducting wires individually connected to the pair of electrodes of each electrode plate, and it is attached on an LCD. An LCD-integrated touch panel like this is adapted to fit to an LCD in size. On this account, the following are required. The first is that electrodes of the LCD are insulated from the transparent conductive film. The second is that in comparison to an insulating region (hereinafter also referred to as “frame border”) provided around the transparent conductive film, the frame border of the touch panel is made smaller. Therefore, in gluing the flexible wiring board to the pair of electrode plates with a conductive adhesive, the conductive adhesive can sometimes stream into a display region of the pair of electrode plates, narrowing the display region. Also, the conductive adhesive having streamed into the display region can cause the short circuit of the transparent conductive films of the pair of electrode plates. Further, the position to insert the flexible wiring board in is restricted, which sometimes leads to the defective contact between the flexible wiring board and pairs of electrodes that the paired electrode plates have respectively. Japanese Unexamined Patent Publication (Kokai) No. 2003-150315 discloses an LCD-integrated touch panel which can prevent occurrence of defectives because the panel is arranged so that a conductive adhesive never streams into a display region even when the adhesive is melted. As to the touch panel, the substrate of each electrode plate is provided with a portion protruding from a side thereof, and on the protruding portion, a flexible wiring board is connected with a pair of electrodes of each electrode plate when connecting the board between the protruding portions.

As stated in the Patent Publication No. 2003-150315, in the case where each electrode plate is provided with a protruding portion used for connection with a flexible wiring board, and the wiring board is connected to and between protruding portions, a touch panel having a pair of electrode plates with the frame border narrowed in all the four sides can be materialized. However, a transparent conductive film is formed over whole surfaces of the first and second electrode plates, and therefore when the paired electrode plates have such protruding portions, they end up affecting and deteriorating the linearity of electric potential gradient (or uniform potential distribution) produced by application of a voltage to the paired electrode plates.

### SUMMARY OF THE INVENTION

Hence, it is an object of the invention to provide a touch panel such that the linearity of electric potential gradient is not deteriorated even when the protruding portions as stated above are provided.

To achieve the above-described object, the invention provides a touch panel having features as described below.

That is, according to the first aspect of the invention, the touch panel is characterized by including: a pair of electrode plates each having an insulating board, a transparent conductive film provided on a surface of the insulating board, a pair of electrodes connected to the transparent conductive film, and a local protruding region in an outer edge portion thereof, and assembled into a relative relation such that the transparent conductive films are opposed to and spaced apart from each other, but can be brought into electrical contact; and a flexible wiring board held between the local protruding regions, and having conducting wires individually connected to the pair of electrodes of each electrode plate, provided that the local protruding region of at least one of the pair of electrode plates is electrically insulated from the transparent conductive film thereof.

According to the second aspect of the invention, the touch panel according to the first aspect is characterized in that the at least one electrode plate is formed so that the local protruding region electrically insulated from the transparent conductive film includes a protruding board portion locally protruding outward from a region of the insulating board located between the pair of electrodes.

According to the third aspect of the invention, the touch panel according to the second aspect is characterized in that the local protruding region of the at least one electrode plate further includes a second conductive film provided on one surface of the protruding board portion and insulated from the transparent conductive film.

According to the fourth aspect of the invention, the touch panel according to the second aspect is characterized in that the local protruding region of the at least one electrode plate has a pair of terminals formed directly on one surface of the protruding board portion, and individually connected to the pair of electrodes.

According to the fifth aspect of the invention, the touch panel according to any one of the first to fourth aspects is characterized in that the insulating board of one of the pair of electrode plates includes a plastic film, on which the transparent conductive film is provided, and a rigid plate which supports the plastic film.

According to the sixth aspect of the invention, the touch panel according to the fifth aspect is characterized in that the local protruding region of the at least one electrode plate has a protruding film portion locally protruding outward from an outer edge of the plastic film, and the rigid plate supports a portion of the plastic film other than the protruding film portion.

According to the seventh aspect of the invention, the touch panel according to any one of the first to sixth aspects is characterized in that an input operation region defined between and by the pairs of the electrodes of the pair of electrode plates includes a first operation region of low resolution near the local protruding regions and a second operation region of high resolution spaced away farther from the local protruding regions.

According to the eighth aspect of the invention, the touch panel according to the seventh aspect is characterized in that display parts for displaying functions corresponding to the first and second operation regions are provided on the insulating board of one of the pair of electrode plates.

According to the ninth aspect of the invention, the touch panel according to the seventh or eighth aspect is characterized by further including dot spacers located between the transparent conductive films of the pair of electrode plates, and discretely disposed over a substantially whole surface of one transparent conductive film, provided that the density of the dot spacers in the first operation region is higher than that in the second operation region.

According to the tenth aspect of the invention, the touch panel is characterized by including: a pair of electrode plates each having an insulating board, a transparent conductive film provided on a surface of the insulating board, a pair of electrodes connected to the transparent conductive film, and a local protruding region in an outer edge portion thereof, and assembled into a relative relation such that the transparent conductive films are opposed to and spaced apart from each other, but can be brought into electrical contact; and a flexible wiring board held between the local protruding regions, and having conducting wires individually connected to the pair of electrodes of each electrode plate, provided that an input operation region defined between and by the pairs of electrodes of the pair of electrode plates includes a first operation region of low resolution near the local protruding regions and a second operation region of high resolution spaced away farther from the local protruding regions.

With the touch panel according to the first aspect, as the local protruding region is electrically insulated from the transparent conductive film in at least one of the pair of electrode plates, the local protruding region can be prevented from deteriorating the linearity of electric potential gradient of the touch panel.

With the touch panel according to the second aspect, as the local protruding region including a protruding board portion locally protruding outward from a region of the insulating board located between the pair of electrodes is formed, the invention is useful when the local protruding region is laid out in such location.

With the touch panel according to the third aspect, the deterioration of the linearity of electric potential gradient of the touch panel can be prevented with reliability.

With the touch panel according to the fourth aspect, as the transparent conductive film is not formed in the local protruding region of the at least one of the pair of electrode plates, the number of steps for insulation processing to form the second conductive film can be cut.

With the touch panel according to the fifth aspect, the touch panel can be stuck to an LCD or the like easily.

With the touch panel according to the sixth aspect, as the local protruding region of the at least one of the pair of electrode plates is not supported by the rigid plate, the touch panel is adaptable to the area to which the panel is attached e.g. when it is attached to a narrow area.

With the touch panel according to the seventh aspect, in the input operation region defined between and by the pairs of electrodes of the pair of electrode plates, the first operation region may be used for a low resolution use e.g. input by a ten key, and the second operation region may be used for a high-resolution use e.g. input by a pen.

With the touch panel according to the eighth aspect, a user can readily grasp the display parts for displaying functions corresponding to the first and second operation regions.

With the touch panel according to the ninth aspect, as the first operation region can be used as a switch input area that no entry can be made at the slightest touch by user's hand because of its high dot spacer density, and the second operation region can be used as e.g. a letter input area which can be made to work with a small input load because of its low dot spacer density.

With the touch panel according to the tenth aspect, in the input operation region defined between and by the pairs of electrodes of the pair of electrode plates, the first operation region can be used for a low resolution use e.g. input by a ten key, and the second operation region can be used for a high-resolution use e.g. input by a pen. Therefore, even if the linearity of electric potential gradient is distorted, the touch panel is less prone to being affected by it.

### BRIEF DESCRIPTION OF THE DRAWINGS

The above and other objects, features and advantages of the present invention will become more apparent from the following description of preferred embodiments in connection with the accompanying drawings, wherein:

FIG. 1A is a plane view of a touch panel according to the first embodiment of the invention;

FIG. 1B is a sectional view of the touch panel taken along the line 1B-1B shown in FIG. 1A;

FIG. 2 is a diagram showing a pair of electrode plates of the touch panel according to the first embodiment;

FIG. 3 is a diagram showing a transparent electrode film formed on the electrode plate of the touch panel according to the first embodiment;

FIG. 4A is a schematic diagram showing the flow of electric current when a voltage is applied to one of a pair of electrode plates of a touch panel in association with the prior art;

FIG. 4B is a schematic diagram showing the flow of electric current when a voltage is applied to one of the pair of electrode plates of the touch panel in association with the invention;

FIG. 5 is a schematic diagram showing the flow of electric current when a voltage is applied to the other electrode plate of the touch panel;

FIGS. 6A and 6B are illustrations showing coordinates detected when entries are made along cross stripes of a lattice arrayed on the touch panel at regular intervals in the condition where a voltage is applied between electrodes of each electrode plate before and after the invention is adopted respectively;

FIG. 7 is an illustration showing a transparent conductive film of a pair of electrode plates according to the second embodiment of the invention;

FIG. 8 is a sectional view showing a modification of the touch panel, taken along the line B1-B1 shown in FIG. 1A;

FIG. 9 is a sectional view showing a modification of the touch panel obtained by replacing the insulating board 8 as shown in FIGS. 1 and 7 with a transparent plastic plate 80;

FIG. 10 is a sectional view showing another modification of the touch panel, taken along the line B1-B1 shown in FIG. 1;

FIG. 11 is a sectional view of a touch panel according to the third embodiment, taken along the line B1-B1 shown in FIG. 1;

FIG. 12 is a plane view showing a modification of the touch panel according to the third embodiment; and,

FIG. 13 is a sectional view of another modification of the touch panel according to the third embodiment, taken along the line B1-B1 shown in FIG. 1.

### DESCRIPTION OF THE PREFERRED EMBODIMENTS

The embodiments of the present invention are described below in detail, with reference to the accompanying drawings. In the drawings, the same or similar components are denoted by common reference numerals.

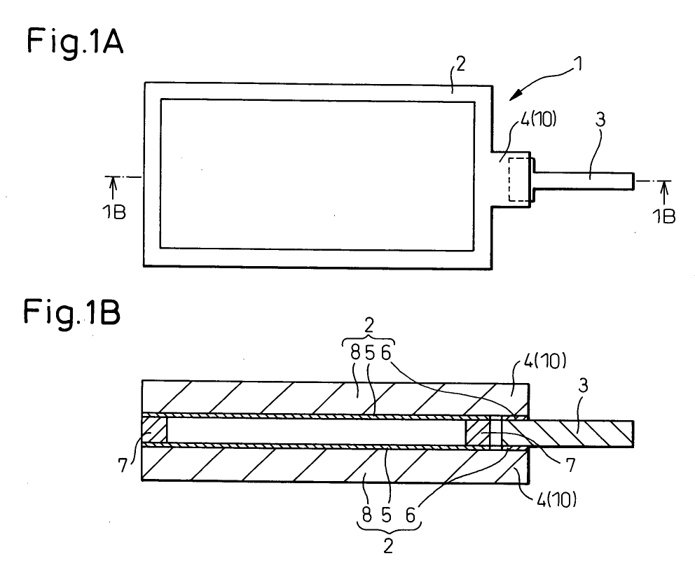

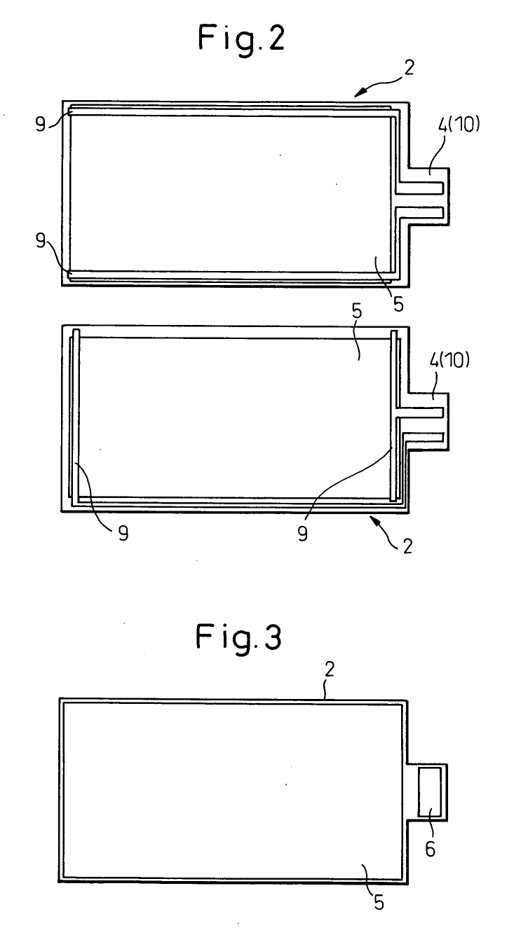

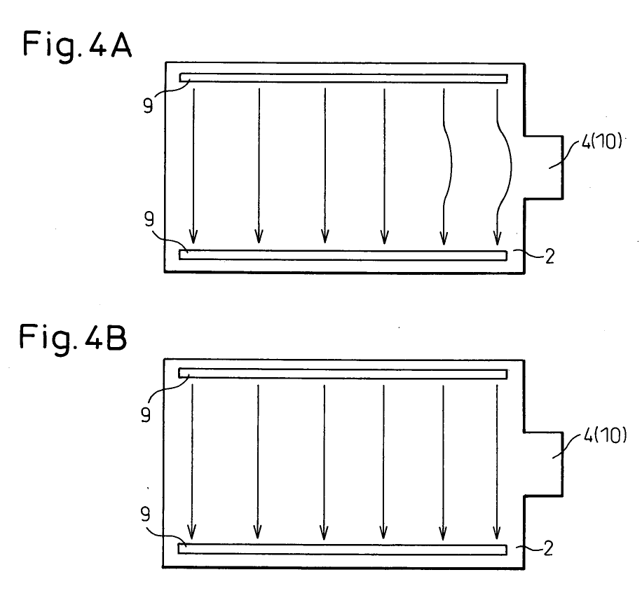

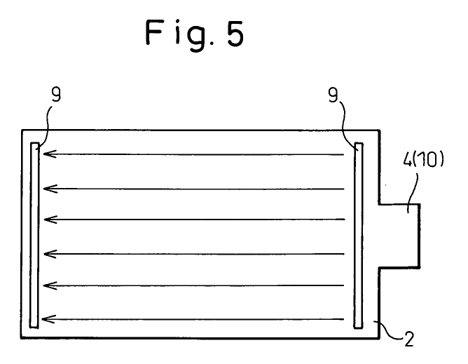

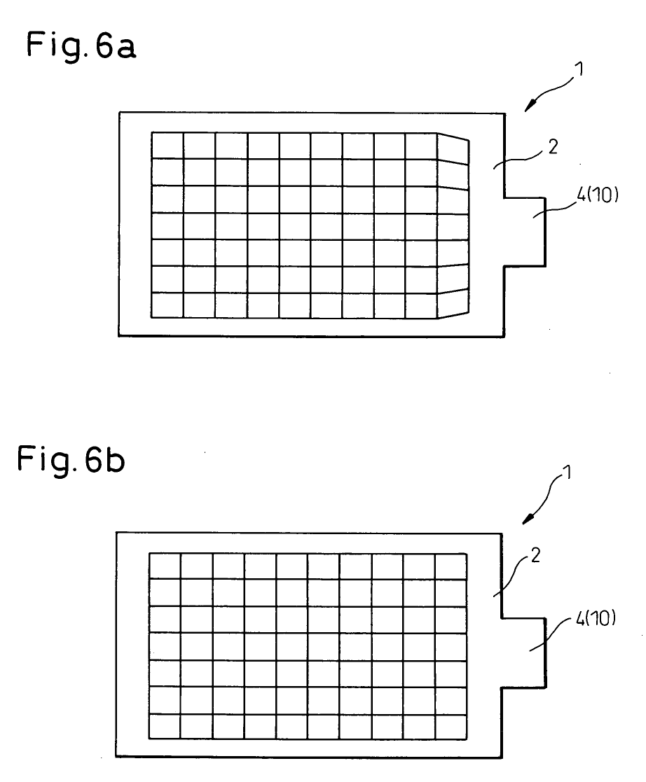

Referring to the drawings, FIG. 1A is a plane view of a touch panel 1 according to the first embodiment, and FIG. 1B is a sectional view of the touch panel taken along the line 1B-1B shown in FIG. 1A. FIG. 2 shows a pair of electrode plates 2 of the touch panel 1. FIG. 3 schematically shows a transparent conductive film 5 and a second conductive film 6, both formed on each of the paired electrode plates 2; the conductive film 5 is made of ITO (Indium Tin Oxide) in general. FIGS. 4A and 4B schematically show how electric current flows when a voltage is applied to one of the pair of electrode plates 2. Specifically, FIG. 4A shows the flow of current when the invention is not adopted, and FIG. 4B shows the flow of current when the invention is adopted. FIG. 5 schematically shows how electric current flows when a voltage is applied to the other electrode plate 2 (before and after the invention is adopted). FIGS. 6A and 6B show coordinates detected when entries are made along cross stripes of a lattice arrayed on the touch panel at regular intervals in the condition where a voltage is applied to the pair of electrode plates 2, provided that FIGS. 6A and 6B show situations before and after the invention is adopted respectively.

As shown in FIGS. 1A, 1B, 2 and 3, the touch panel 1 includes a pair of electrode plates 2 each having an insulating board 8, a transparent conductive film 5 provided on a surface of the insulating board 8, a pair of electrodes 9 connected to the transparent conductive film 5, and a local protruding region 10 in an outer edge portion of the electrode plate 2; the paired electrode plates 2 are assembled into a relative relation such that the transparent conductive films 5 are opposed to and spaced apart from each other, but can be brought into electrical contact. Also, the touch panel 1 includes a flexible wiring board 3 held between the local protruding regions 10, and having conducting wires individually connected to the pair of electrodes 9 of each electrode plate 2. The local protruding region 10 of at least one of the pair of electrode plates 2 is electrically insulated form the transparent conductive film 5 thereof. In addition, in the at least one electrode plate, the local protruding region 10 electrically insulated from the transparent conductive film 5 is formed so that it includes a protruding board portion 4 locally protruding outward from a region located between the pair of electrodes 9 on the insulating board. The local protruding region 10 of the at least one electrode plate 2 further includes a second conductive film 6 provided on one surface of the protruding board portion 4, and insulated from the transparent conductive film 5.

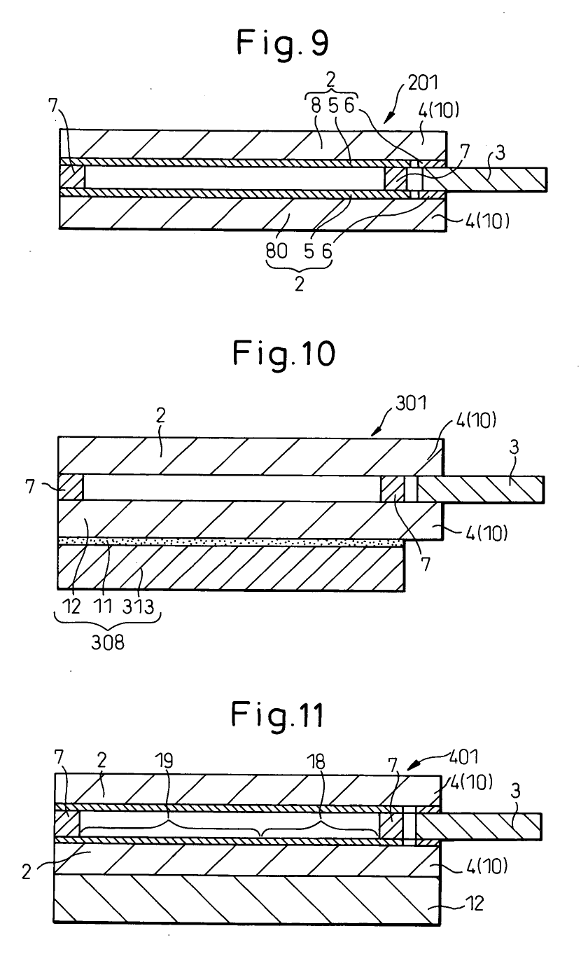

As in the at least one electrode plate 2, the local protruding region 10 electrically is insulated from the transparent conductive film 5, it is possible to prevent the local protruding region 10 from deteriorating the linearity of electric potential gradient in the touch panel 1. In addition, the at least one electrode plate 2 is formed so that the local protruding region 10 electrically insulated from the transparent conductive film 5 includes the protruding board portion 4 locally protruding outward from the region located between the pair of electrodes on the insulating board and as such, the invention is particularly useful when the local protruding region 10 lies in such location. Further, as the local protruding region 10 of the at least one electrode plate 2 includes the second conductive film 6, which is provided on the one surface of the protruding board portion 4, and insulated from the transparent conductive film 5, it is possible to prevent the deterioration in linearity of the electric potential gradient in the touch panel with reliability. Also, the insulating board 8 of one of the pair of electrode plates 2 may be composed of a plastic plate 80 as shown in FIG. 9. In this case, the plastic plate 80 can be stuck on an LCD or the like easily.

Now, this will be explained taking an example. FIG. 4A schematically shows the flow of electric current when a voltage is applied between the pair of electrodes 9 in the case where the transparent conductive film 5 is formed over an entire surface of one of the pair of electrode plates 2 according to the prior art. FIG. 4B schematically shows the flow of electric current when a voltage is applied between the pair of electrodes 9 in the case where the transparent conductive film 5 and the second conductive film 6 are formed on one of the pair of electrode plates 2 according to the first embodiment. In the case of the transparent conductive film 5 formed over the entire surface, as the current flows approaching the protruding board portion 4, it is shown that the linearity of electric potential gradient is deteriorated near the protruding board portion 4.

Referring to FIG. 5, the flow of electric current when a voltage is applied between the pair of electrodes 9 on the other of the pair of electrode plates 2 is shown schematically. It is shown that the flow of the current is not changed near the protruding board portion 4 even when the transparent conductive film 5 is formed over the entire surface of the electrode plate 2 because of the current flowing between the paired electrodes 9, and therefore the linearity of electric potential gradient is not deteriorated. Hence, it does not matter whether the second transparent conductive film 6 is formed on the protruding board portion 4 or not. In other words, it suffices that the local protruding region of at least one of the pair of electrode plates 2 is electrically insulated from the transparent conductive film.

Referring to FIG. 6A, coordinates detected when entries are made along cross stripes of a lattice arrayed at regular intervals on the touch panel in the condition where a voltage is applied between the pair of electrodes 9 of each electrode plate 2 are shown. The linearity of electric potential gradient is deteriorated when the transparent conductive film 5 is formed over the entire surface of the electrode plate 2, and thus the coordinates detected near the protruding board portion 4 no longer follow the cross stripes of a lattice arrayed at regular intervals. Therefore, for example, even when a user intends to touch the panel on the lattice square which is the second one from the top in the rightmost column in FIG. 6B, the user may be judged as having touched the lattice square which is the first one from the top in the rightmost column. In contrast, when the transparent conductive film 5 and second conductive film 6 are formed, the detected coordinates follow the cross stripes of a lattice arrayed at regular intervals even near the protruding board portion 4, and therefore a misjudgment like that is never made.

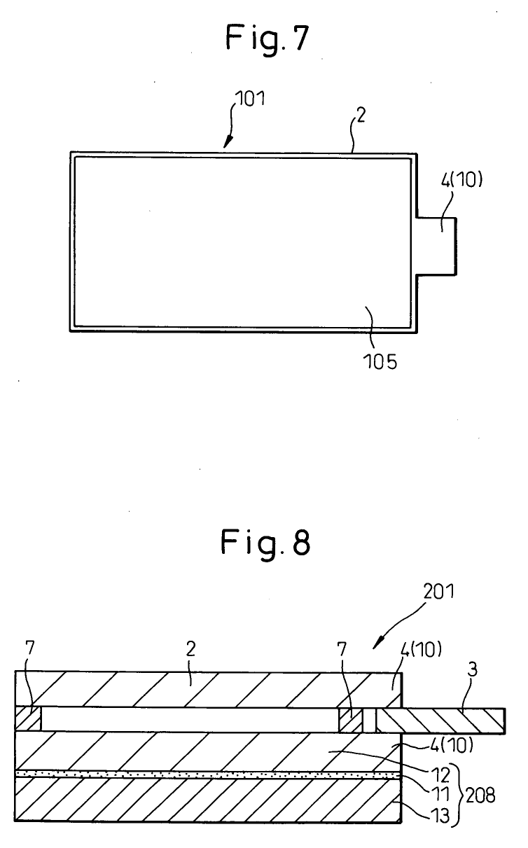

Now, a touch panel 101 according to the second embodiment has substantially the same structure as that of the touch panel 1 according to the first embodiment except that the second conductive film 6 is not formed on the protruding board portion 4 of at least one of the pair of electrode plates 2. Therefore, corresponding components are denoted by common reference numerals, and their descriptions are skipped. FIG. 7 shows a shape of a transparent conductive film 105 of the pair of electrode plates 2 according to the second embodiment. A local protruding region 10 of at least one of the pair of electrode plates 2 has a pair of terminals formed directly on a surface of a protruding board portion 4, and individually connected with the pair of electrodes as described above. On the protruding board portion 4 of one of the pair of electrode plates 2, the second conductive film 6 is not formed. This makes it possible to prevent the deterioration in the linearity of voltage gradient in the touch panel 101, and eliminates the need for forming an insulating layer for separating the transparent conductive film 5 from the second conductive film 6 located on the protruding board portion 4 of at least one of the pair of electrode plates 2 as in the first embodiment. Thus, the number of manufacturing processes of the touch panel can be reduced in comparison to that in the first embodiment. Now, in this embodiment, after the transparent conductive film 105 has been formed over the whole surface of each electrode plate 2, a portion of the transparent conductive film located on the protruding board portion 4 may be removed. Further, as the second transparent conductive film 6 is not formed on the protruding board portion 4, the insulating layer, which has needed to be on the portion in order to prevent a short circuit conventionally, becomes unnecessary. In addition, as in FIG. 9, the insulating board 8 of one of the pair of electrode plates 2 may be composed of a plastic plate 80. In this case, the plastic plate 80 can be stuck on an LCD or the like easily.

Referring to FIG. 8, a sectional view of a touch panel 201 as a modification of the above-described touch panel is presented, which is taken along the line B1-B1 shown in FIG. 1A. With the touch panel 201, an insulating board 208 corresponding to the insulating board of at least one of the paired electrode plates of the touch panel 1 of the first embodiment or the touch panel 101 of the second embodiment has a plastic film 12; on one exterior surface of the plastic film on the opposite side to the other exterior surface thereof facing the electrode plate 2 is stuck a transparent plastic plate 13 with a glue 11. Except for this point, the touch panel 201 has substantially the same structure as that of the touch panel according to the first or second embodiment. Therefore, the corresponding components are denoted by common reference numerals, and their descriptions are skipped.

The insulating board 208 of the one electrode plate includes: a plastic film 12, on which the transparent conductive film 5 is provided; and a rigid plate 13 supporting the plastic film 12, e.g. a transparent plastic plate 13. As the plastic film 12 and transparent plastic plate 13 are bonded together with the glue 11, the touch panel 201 is increased in strength, and it can be stuck on an LCD or the like easily. Now, in the case where the insulating board 8 is composed of a plastic plate 80 in the touch panel according to the first or second embodiment, it is obvious that the transparent plastic plate 13 need not be stuck on the insulating board.

Referring to FIG. 10, a sectional view of another modification of the above-described touch panel is presented, which is taken along the line B1-B1 shown in FIG. 1A. The touch panel 301 has substantially the same structure as that of the touch panel according to the first or second embodiment except that the transparent plastic plate 313 is shaped into a rectangular form so as to prevent the transparent plastic plate 313 from being stuck to the protruding board portion 4 of one of the paired electrode plates of the touch panel. Therefore, the corresponding components are denoted by common reference numerals, and their descriptions are skipped. The local protruding region 10 of the at least one electrode plate 2 has a protruding film portion locally protruding outward from an outer edge of the plastic film 12; the rigid plate 313 supports a portion of the plastic film 12 other than the protruding film portion. As the transparent plastic plate 313 is shaped into a rectangular form so as to prevent the transparent plastic plate 313 from being stuck to the protruding board portion 4, this touch panel is adaptable in the area to which the panel is attached e.g. when it is attached to a narrow area.

Referring to FIG. 11, a sectional view of a touch panel according to the third embodiment is presented, which is taken along the line B1-B1 shown in FIG. 1A. The touch panel 401 has substantially the same structure as that of the touch panel according to the first embodiment except that the touch panel 401 is provided with a first operation region 18 and a second operation region 19. Therefore, corresponding components are denoted by common reference numerals, and their descriptions are skipped. An input operation region defined between and by the pairs of electrodes 9 of the pair of electrode plates 2 includes a first operation region 18 of low resolution near the local protruding regions 10 and a second operation region 19 of high resolution spaced away farther from the local protruding regions 10. The first operation region 18 may be used for a low-resolution use e.g. input by a ten key. The second operation region 19 may be used for a high-resolution use e.g. input by a pen. Therefore, even if the linearity of electric potential gradient is distorted, the touch panel is less prone to being affected by it. Further, as stated above, in the case where the local protruding regions 10 of the pair of electrode plates are not electrically insulated from the transparent conductive film 5, even if the linearity of electric potential gradient is distorted, the touch panel is less prone to being affected by it, as long as the input operation region defined between and by the pairs of electrodes 9 of the pair of electrode plates 2 includes the first operation region 18 of low resolution near the local protruding regions 10 and the second operation region 19 of high resolution spaced away farther from the local protruding regions 10.

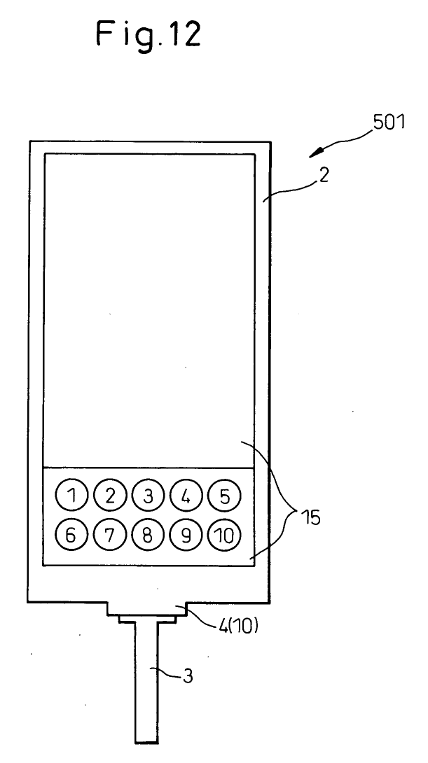

Referring to FIG. 12, a plane view of a modification of the touch panel according to the third embodiment is presented. The touch panel 501 has substantially the same structure as that of the touch panel according to the third embodiment except that display parts 15 are stuck to the insulating board 8 or transparent plastic plate 13. Therefore, corresponding components are denoted by common reference numerals, and their descriptions are skipped. On the insulating board 8 of one of a pair of electrode plates 2, display parts 15 for displaying functions corresponding to the first and second operation regions 18 and 19 are provided respectively. As the display parts 15 for displaying functions corresponding to the first and second operation regions 18 and 19 are provided, a user can readily grasp what functions the touch panel has.

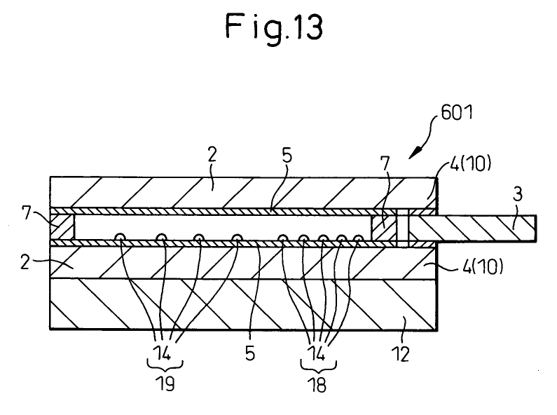

Referring to FIG. 13, a sectional view of another modification of the touch panel according to the third embodiment is presented. The touch panel 601 according to fifth embodiment has substantially the same structure as that of the touch panel according to the third embodiment except that one of a pair of electrode plates thereof has dot spacers 14 provided at two kinds of intervals. Therefore, corresponding components are denoted by common reference numerals, and their descriptions are skipped. Specifically, the touch panel 601 further includes dot spacers 14, which are located between the transparent conductive films 5 of the pair of electrode plates 2, and discretely disposed over a substantially whole surface of one conductive film 5. The density of the dot spacers 14 in the first operation region 18 is higher than that in the second operation region 19. On this account, the first operation region 18 can be used as e.g. a switch input area that no entry can be made at the slightest touch by user's hand, and the second operation region 19 can be used as e.g. a letter input area which can be made to work with a small input load because of its low density of the dot spacers 14.

What is claimed is:

1. A touch panel, comprising:
a pair of electrode plates each having an insulating board,
a transparent conductive film provided on a surface of the insulating board;
a pair of electrodes connected to the transparent conductive film, and,
a local protruding region in an outer edge portion thereof, and,
the pair of electrode plates assembled into a relative relation such that the transparent conductive films are opposed to and spaced apart from each other, but can be brought into electrical contact; and,
a flexible wiring board held between the local protruding regions, and having conducting wires individually connected to the pair of electrodes of each electrode plate,
wherein the local protruding region of at least one of the pair of electrode plates is electrically insulated from the transparent conductive film thereof.

2. The touch panel according to claim 1, wherein the at least one electrode plate is formed so that the local protruding region electrically insulated from the transparent conductive film includes a protruding board portion locally protruding outward from a region of the insulating board located between the pair of electrodes.

3. The touch panel according to claim 2, wherein the local protruding region of the at least one electrode plate further includes a second conductive film provided on one surface of the protruding board portion and insulated from the transparent conductive film.

4. The touch panel according to claim 2, wherein the local protruding region of the at least one electrode plate has a pair of terminals formed directly on one surface of the protruding board portion, and individually connected to the pair of electrodes.

5. The touch panel according to claim 1, wherein the insulating board of one of the pair of electrode plates includes: a plastic film, on which the transparent conductive film is provided; and a rigid plate which supports the plastic film.

6. The touch panel according to claim 2, wherein the insulating board of one of the pair of electrode plates includes: a plastic film, on which the transparent conductive film is provided; and a rigid plate which supports the plastic film.

7. The touch panel according to claim 3, wherein the insulating board of one of the pair of electrode plates includes: a plastic film, on which the transparent conductive film is provided; and a rigid plate which supports the plastic film.

8. The touch panel according to claim 4, wherein the insulating board of one of the pair of electrode plates includes: a plastic film, on which the transparent conductive film is provided; and a rigid plate which supports the plastic film.

9. The touch panel according to claim 5, wherein the local protruding region of the at least one electrode plate has a protruding film portion locally protruding outward from an outer edge of the plastic film, and
the rigid plate supports a portion of the plastic film other than the protruding film portion.

10. The touch panel according to claim 6, wherein the local protruding region of the at least one electrode plate has a protruding film portion locally protruding outward from an outer edge of the plastic film, and
the rigid plate supports a portion of the plastic film other than the protruding film portion.

11. The touch panel according to claim 7, wherein the local protruding region of the at least one electrode plate has a protruding film portion locally protruding outward from an outer edge of the plastic film, and
the rigid plate supports a portion of the plastic film other than the protruding film portion.

12. The touch panel according to claim 8, wherein the local protruding region of the at least one electrode plate has a protruding film portion locally protruding outward from an outer edge of the plastic film, and
the rigid plate supports a portion of the plastic film other than the protruding film portion.

13. The touch panel according to claim 1, wherein an input operation region defined between and by the pairs of the electrodes of the pair of electrode plates includes a first operation region of low resolution near the local protruding regions and a second operation region of high resolution spaced away farther from the local protruding regions.

14. The touch panel according to claim 2, wherein an input operation region defined between and by the pairs of the electrodes of the pair of electrode plates includes a first operation region of low resolution near the local protruding regions and a second operation region of high resolution spaced away farther from the local protruding regions.

15. The touch panel according to claim 3, wherein an input operation region defined between and by the pairs of the electrodes of the pair of electrode plates includes a first operation region of low resolution near the local protruding regions and a second operation region of high resolution spaced away farther from the local protruding regions.

16. The touch panel according to claim 4, wherein an input operation region defined between and by the pairs of the electrodes of the pair of electrode plates includes a first operation region of low resolution near the local protruding regions and a second operation region of high resolution spaced away farther from the local protruding regions.

17. The touch panel according to claim 5, wherein an input operation region defined between and by the pairs of the electrodes of the pair of electrode plates includes a first operation region of low resolution near the local protruding regions and a second operation region of high resolution spaced away farther from the local protruding regions.

18. The touch panel according to claim 6, wherein an input operation region defined between and by the pairs of the electrodes of the pair of electrode plates includes a first operation region of low resolution near the local protruding regions and a second operation region of high resolution spaced away farther from the local protruding regions.

19. The touch panel according to claim 7, wherein an input operation region defined between and by the pairs of the electrodes of the pair of electrode plates includes a first operation region of low resolution near the local protruding regions and a second operation region of high resolution spaced away farther from the local protruding regions.

20. The touch panel according to claim 8, wherein an input operation region defined between and by the pairs of the electrodes of the pair of electrode plates includes a first operation region of low resolution near the local protruding regions and a second operation region of high resolution spaced away farther from the local protruding regions.

21. The touch panel according to claim 9, wherein an input operation region defined between and by the pairs of the electrodes of the pair of electrode plates includes a first operation region of low resolution near the local protruding regions and a second operation region of high resolution spaced away farther from the local protruding regions.

22. The touch panel according to claim 10, wherein an input operation region defined between and by the pairs of the electrodes of the pair of electrode plates includes a first operation region of low resolution near the local protruding regions and a second operation region of high resolution spaced away farther from the local protruding regions.

23. The touch panel according to claim 11, wherein an input operation region defined between and by the pairs of the electrodes of the pair of electrode plates includes a first operation region of low resolution near the local protruding regions and a second operation region of high resolution spaced away farther from the local protruding regions.

24. The touch panel according to claim 12, wherein an input operation region defined between and by the pairs of the electrodes of the pair of electrode plates includes a first operation region of low resolution near the local protruding regions and a second operation region of high resolution spaced away farther from the local protruding regions.

25. The touch panel according to claim 13, wherein display parts for displaying functions corresponding to the first and second operation regions are provided on the insulating board of one of the pair of electrode plates.

26. The touch panel according to claim 14, wherein display parts for displaying functions corresponding to the first and second operation regions are provided on the insulating board of one of the pair of electrode plates.

27. The touch panel according to claim 15, wherein display parts for displaying functions corresponding to the first and second operation regions are provided on the insulating board of one of the pair of electrode plates.

28. The touch panel according to claim 16, wherein display parts for displaying functions corresponding to the first and second operation regions are provided on the insulating board of one of the pair of electrode plates.

29. The touch panel according to claim 17, wherein display parts for displaying functions corresponding to the first and second operation regions are provided on the insulating board of one of the pair of electrode plates.

30. The touch panel according to claim 18, wherein display parts for displaying functions corresponding to the first and second operation regions are provided on the insulating board of one of the pair of electrode plates.

31. The touch panel according to claim 19, wherein display parts for displaying functions corresponding to the first and second operation regions are provided on the insulating board of one of the pair of electrode plates.

32. The touch panel according to claim 20, wherein display parts for displaying functions corresponding to the first and second operation regions are provided on the insulating board of one of the pair of electrode plates.

33. The touch panel according to claim 21, wherein display parts for displaying functions corresponding to the first and second operation regions are provided on the insulating board of one of the pair of electrode plates.

34. The touch panel according to claim 22, wherein display parts for displaying functions corresponding to the first and second operation regions are provided on the insulating board of one of the pair of electrode plates.

35. The touch panel according to claim 23, wherein display parts for displaying functions corresponding to the first and second operation regions are provided on the insulating board of one of the pair of electrode plates.

36. The touch panel according to claim 24, wherein display parts for displaying functions corresponding to the first and second operation regions are provided on the insulating board of one of the pair of electrode plates.

37. The touch panel according to claim 13, further comprising dot spacers located between the transparent conductive films of the pair of electrode plates, and discretely disposed over a substantially whole surface of one transparent conductive film, wherein the density of the dot spacers in the first operation region is higher than that in the second operation region.

38. The touch panel according to claim 14, further comprising dot spacers located between the transparent conductive films of the pair of electrode plates, and discretely disposed over a substantially whole surface of one transparent conductive film, wherein the density of the dot spacers in the first operation region is higher than that in the second operation region.

39. The touch panel according to claim 15, further comprising dot spacers located between the transparent conductive films of the pair of electrode plates, and discretely disposed over a substantially whole surface of one transparent conductive film, wherein the density of the dot spacers in the first operation region is higher than that in the second operation region.

40. The touch panel according to claim 16, further comprising dot spacers located between the transparent conductive films of the pair of electrode plates, and discretely disposed over a substantially whole surface of one transparent conductive film, wherein the density of the dot spacers in the first operation region is higher than that in the second operation region.

41. The touch panel according to claim 17, further comprising dot spacers located between the transparent conductive films of the pair of electrode plates, and discretely disposed over a substantially whole surface of one transparent conductive film, wherein the density of the dot spacers in the first operation region is higher than that in the second operation region.

42. The touch panel according to claim 18, further comprising dot spacers located between the transparent conductive films of the pair of electrode plates, and discretely disposed over a substantially whole surface of one transparent conductive film, wherein the density of the dot spacers in the first operation region is higher than that in the second operation region.

43. The touch panel according to claim 19, further comprising dot spacers located between the transparent conductive films of the pair of electrode plates, and discretely disposed over a substantially whole surface of one transparent conductive film, wherein the density of the dot spacers in the first operation region is higher than that in the second operation region.

44. The touch panel according to claim 20, further comprising dot spacers located between the transparent conductive films of the pair of electrode plates, and discretely disposed over a substantially whole surface of one transparent conductive film, wherein the density of the dot spacers in the first operation region is higher than that in the second operation region.

45. The touch panel according to claim 21, wherein display parts for displaying functions corresponding to the first and second operation regions are provided on the insulating board of one of the pair of electrode plates.

46. The touch panel according to claim 22, further comprising dot spacers located between the transparent conductive films of the pair of electrode plates, and discretely disposed over a substantially whole surface of one transparent conductive film, wherein the density of the dot spacers in the first operation region is higher than that in the second operation region.

47. The touch panel according to claim 23, further comprising dot spacers located between the transparent conductive films of the pair of electrode plates, and discretely disposed over a substantially whole surface of one transparent conductive film, wherein the density of the dot spacers in the first operation region is higher than that in the second operation region.

48. The touch panel according to claim 24, further comprising dot spacers located between the transparent conductive films of the pair of electrode plates, and discretely disposed over a substantially whole surface of one transparent conductive film, wherein the density of the dot spacers in the first operation region is higher than that in the second operation region.

49. The touch panel according to claim 25, further comprising dot spacers located between the transparent conductive films of the pair of electrode plates, and discretely disposed over a substantially whole surface of one transparent conductive film, wherein the density of the dot spacers in the first operation region is higher than that in the second operation region.

50. The touch panel according to claim 26, further comprising dot spacers located between the transparent conductive films of the pair of electrode plates, and discretely disposed over a substantially whole surface of one transparent conductive film, wherein the density of the dot spacers in the first operation region is higher than that in the second operation region.

51. The touch panel according to claim 27, further comprising dot spacers located between the transparent conductive films of the pair of electrode plates, and discretely disposed over a substantially whole surface of one transparent conductive film, wherein the density of the dot spacers in the first operation region is higher than that in the second operation region.

52. The touch panel according to claim 28, further comprising dot spacers located between the transparent conductive films of the pair of electrode plates, and discretely disposed over a substantially whole surface of one transparent conductive film, wherein the density of the dot spacers in the first operation region is higher than that in the second operation region.

53. The touch panel according to claim 29, further comprising dot spacers located between the transparent conductive films of the pair of electrode plates, and discretely disposed over a substantially whole surface of one transparent conductive film, wherein the density of the dot spacers in the first operation region is higher than that in the second operation region.

54. The touch panel according to claim 30, further comprising dot spacers located between the transparent conductive films of the pair of electrode plates, and discretely disposed over a substantially whole surface of one transparent conductive film, wherein the density of the dot spacers in the first operation region is higher than that in the second operation region.

55. The touch panel according to claim 31, further comprising dot spacers located between the transparent conductive films of the pair of electrode plates, and discretely disposed over a substantially whole surface of one transparent conductive film, wherein the density of the dot spacers in the first operation region is higher than that in the second operation region.

56. The touch panel according to claim 32, further comprising dot spacers located between the transparent conductive films of the pair of electrode plates, and discretely disposed over a substantially whole surface of one transparent conductive film, wherein the density of the dot spacers in the first operation region is higher than that in the second operation region.

57. The touch panel according to claim 33, further comprising dot spacers located between the transparent conductive films of the pair of electrode plates, and discretely disposed over a substantially whole surface of one transparent conductive film, wherein the density of the dot spacers in the first operation region is higher than that in the second operation region.

58. The touch panel according to claim 34, further comprising dot spacers located between the transparent conductive films of the pair of electrode plates, and discretely disposed over a substantially whole surface of one transparent conductive film, wherein the density of the dot spacers in the first operation region is higher than that in the second operation region.

59. The touch panel according to claim 35, further comprising dot spacers located between the transparent conductive films of the pair of electrode plates, and discretely disposed over a substantially whole surface of one transparent conductive film, wherein the density of the dot spacers in the first operation region is higher than that in the second operation region.

60. The touch panel according to claim 36, further comprising dot spacers located between the transparent conductive films of the pair of electrode plates, and discretely disposed over a substantially whole surface of one transparent conductive film, wherein the density of the dot spacers in the first operation region is higher than that in the second operation region.

61. A touch panel, comprising:
a pair of electrode plates each having an insulating board,
a transparent conductive film provided on a surface of the insulating board;
a pair of electrodes connected to the transparent conductive film, and,
a local protruding region in an outer edge portion thereof; and,
the pair of electrode plates assembled into a relative relation such that the transparent conductive films are opposed to and spaced apart from each other, but can be brought into electrical contact; and,
a flexible wiring board held between the local protruding regions, and having conducting wires individually connected to the pair of electrodes of each electrode plate,
wherein an input operation region defined between and by the pairs of electrodes of the pair of electrode plates includes a first operation region of low resolution near the local protruding regions and a second operation region of high resolution spaced away farther from the local protruding regions.
